(19) United States
(12) Patent Application Publication
(10) Pub. No.: US 2010/0131899 A1
(43) Pub. Date: May 27, 2010

(54) Scannable Cloud

(75) Inventor: Thierry Hubert, Arlington, MA (US)

Correspondence Address: Thierry Hubert, 23 Court Street, Arlington, MA, 02476, US

(73) Assignee: Darwin Ecosystem LLC, Arlington, MA (US)

(21) Appl. No.: 12/580,936

(22) Filed: Oct. 16, 2009

Related U.S. Application Data
(60) Provisional application No. 61/106,223, filed on Oct. 17, 2008.

(51) Int. Cl. G06F 3/048

(52) U.S. Cl. 715/823; 715/825

(57) ABSTRACT

Disclosed herein is a method presenting to a user a tag cloud; wherein the tag cloud keywords' are highlighted based on its correlated records through a passive selection (mouse-over or touchscreen swipe); as well as highlighting its related records list(s) capable of representing the records' relationships within the tag cloud; and this method presents to a user a tag cloud; wherein an active selection (click of a mouse or a touchscreen tap) of a tag or a listed record further filters the list(s) of related records; whereas the tag cloud uncorrelated tags to an active selection remain visible and available for a selection.

### RELATED APPLICATION

This application claims the benefit of U.S. Provisional Application No. 61/106,223 filed on Oct. 17, 2008 named POLYSEMIC NAVIGATION APPARATUS. The entire teachings of the above application are incorporated herein by reference.

The Invention has been renamed herein as SCANNABLE CLOUD to best describe the embodiment of the invention. The justification for the name change is explained by the fact that POLYSEMIC is an word invented by the present inventor to express the invention's ability to present multiple contexts on one screen; and that the name “polysemic” is not known or recognized by one skilled in the art of the invention.

### COPYRIGHT NOTICE

A portion of the disclosure of this patent document contains material that is subject to copyright protection. The copyright owner has no objection to the facsimile reproduction by anyone of the patent document or the patent disclosure, as it appears in a published Patent and Trademark Office patent file or record, but otherwise reserves all copyrights whatsoever.

### FIELD OF THE INVENTION

This disclosure relates to scannable cloud, and more particularly to a system for information consumption.

### BACKGROUND OF THE INVENTION

A tag is a keyword used to classify content. Tags can be defined by the author of the electronically published information, as well as being extracted from the content and/or fields comprising the information. Tags are also generated from internet taxonomies and folksonomies for online use such as document indexing, image indexing and internet Website bookmarks. The use of tags on the Web, also known as tagging, is an important part of the Web 2.0 movement.

Nowadays electronic Information can have one or more tags to simplify classification through software capable providing rapid access to the information according to tags being shared across multiple information items. This methods has improved the retrieval of relevant documents from large bodies of information.

A tag cloud is a visual representation of aggregated tags from content used on a website. They are typically depicted as a collections of alphabetically sorted text tags in different font sizes according to popular ranking. The selection of one tag will extract the record(s) related with that tag in the form of a list. Some sites might also display a new tag cloud representing the tags associated with the selection to allow for more precise indexing and selections. The tag cloud offers a filtering mechanism that leads to a filtered search result according to the selection on one tag leading to a list of items, often capable of displaying a drilled tag cloud. Furthermore, the tag cloud gives the user a weighted overview of the information's corpus classification. Our problem with this approach is in the tag cloud's inability to show the relationships that connect the tags amongst themselves with their listed records. The Scannable Cloud ability to represent the correlation that exists between the keywords and their records offers a more meaningful understanding of the theme's clusters as it accelerates the speed of information consumption. Such a capacity would dramatically improve the comprehension with limited effort in navigation and in reading the detailed content thus accelerating discovering the item(s) of interest. In my method, the user would have the ability to scan over the tags or listed items as the system reveals the relationships between them.

### SUMMARY OF THE INVENTION

Disclosed herein is a method comprising presenting to a user a tag cloud and its related record lists that are correlated through shared and cross-referenced keywords assigned to each record through various extraction methods; herein the keywords and records are highlighted to outline their correlation; herein the keywords are assigned to a categories presenting on the tag cloud in a distinct style using colors, text underlining, text background colors, text boxes or other distinctive representation; wherein the user's passive selection over a keyword or record causes the correlated tag cloud keywords and listed records to be highlighted; wherein the user's active selection of a keyword causes the correlated tag cloud keywords to maintain the highlight and filter the record list(s) with presenting only the records associated with the highlighted keyword selection; wherein subsequent keyword active selection from the highlighted keywords further filters the record list(s); wherein the selection of listed record opens the record's source through a Uniform Resource Locator (URL) or other reference locator as defined by the record source.

### TECHNICAL EFFECTS

The scannable cloud permits the user to observe the clusters of keywords associated with each other from an filtered and categorized list of records without having to further redefine the filter selection to observe the emerging correlated themes. This method also permits the user to actively select a keyword, or select multiple keywords in a highlighted cluster, to further reduce the scope of listed filtered records. It is advantageous to the user's ability gain awareness of the emerging themes and discover the most pertinent records to the user's selection.

### BRIEF DESCRIPTION OF THE DRAWINGS

The subject matter, which is regarded as the invention, is particularly pointed out and distinctly claimed in the claims at the conclusion of the specification. The forgoing and other objects, features, and advantages of the invention are apparent from the following detailed descriptions taken in conjunction with the accompanying drawings in which:

FIG. 1 displays a tag cloud and record list, based upon the user's mouse-over selection of the “Bank of American” keyword, the system highlights (using underlined text) the other keywords and related items from the record list thus providing the user with a context and relevant items.

FIG. 2 displays a tag cloud and record list, based upon the user's mouse-over selection of an item in the record list, the system highlights (using underlined text) the related subset of keywords associated with the mouse-over item thus providing the user with a contextual overview of the item.

FIG. 3 displays a tag cloud and record list, based upon the user's active selection of the “Bank of American” keyword, the system highlights (using green underlined text) the other keywords and filters the related items on the record list thus providing the user with a context and specific items matching the system selected keywords.

FIG. 4 displays a tag cloud and record list, based upon the user's active selection of the “Bank of American” keyword, the system highlights (using green underlined text) the other keywords and filters the related items on the record list thus providing the user with a context and specific items matching the system selected keywords. The figure also demonstrates that the user can mouse-over the “Children” keyword as the system maintains the selection and highlights (using underlined text) the other keywords related to “Children” without loosing the current filter and selected highlights, thus providing the user with the ability to scan other correlations without loosing the initial context.

FIG. 5 displays an actual screen shot of the Invention applied in a working prototype. The figures points out the different components and their relationships through content extracted from the Web's current events. The tag cloud keywords are also enhanced with colors further outline the distinctions between category classes such as People, Places, Events, Product, Organizations, etc. . . . the figure also demonstrates multiple record list correlations to support item type segregation to ease the user's ability to distinguish different information. The figure also displays the context of the query and tools to refine or change the active query. The figure is a demonstration on the Invention.

FIG. 6 displays and demonstrate and actual screen shot, based upon the user selecting the “pandemic” keyword, the system highlights (using a grey background) the other keywords and filters the related items in the image and Web event record lists, thus demonstrating that the user is able to grasp the context and access its related content while keeping the overall context in sight for further passive or active selections.

### DETAILED DESCRIPTION

Disclosed herein is the “scannable cloud” that allows a user to visualize the correlations from categorized and filtered records by scanning and selecting a tag cloud capable of highlighting the related and correlated clusters of keywords and record list items. This methods permits the user to visualize through keywords and record lists without having to refresh the screen as such improving the consumption, awareness and discovery for finding relevant information. It provides the user with the benefit of accelerating the process of understanding the context depicted through the highlighted correlations, thus reducing the need to consume detailed information form the records until a meaningful information is highlighted. As such the present invention offers a new way to raise awareness and discovery through the emergence of correlated information as visible patterns.

The term item make reference to a record stored in a database. The item can be a description, image, video with a URL or other system record locator pointing to its source.

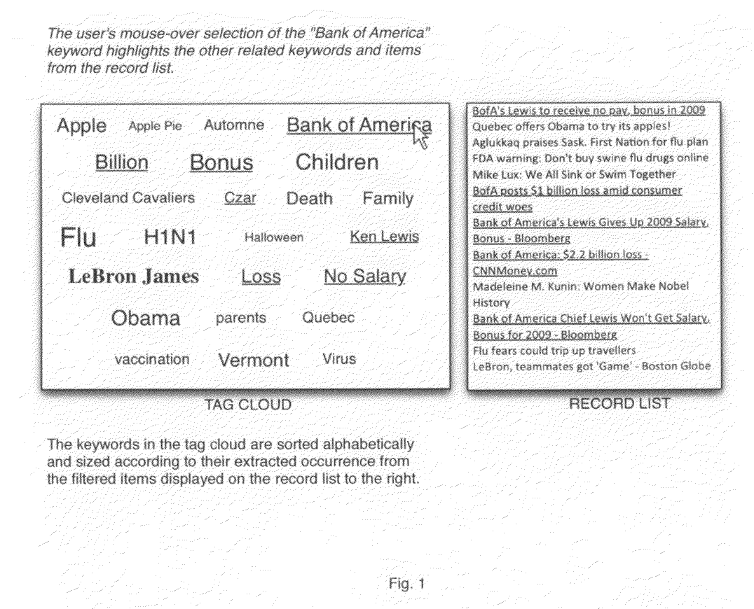

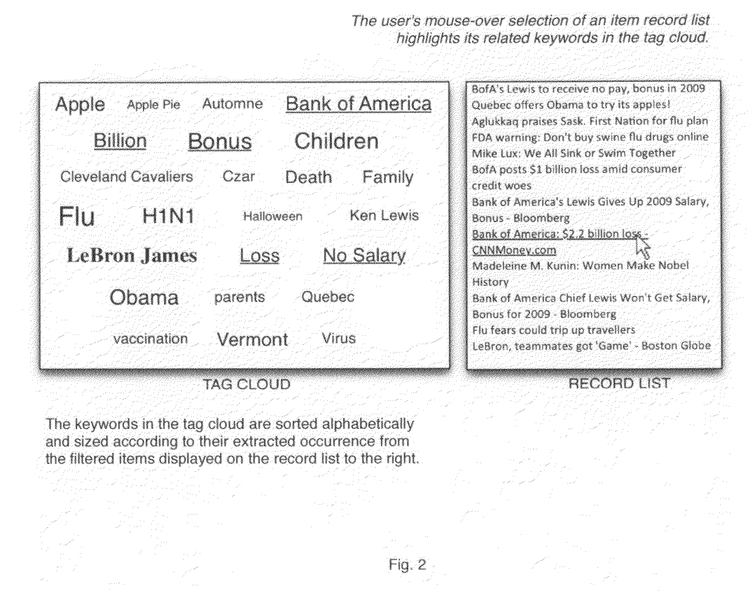

With reference now to the FIG. 1, a tag cloud depicts the most frequent keywords found in a 24 hours news Really Simple Syndication (RSS) feed sorted alphabetically and sized according to their occurrence ranking. In addition to this typical tag cloud representation, the user's mouse-over of the “Bank of America” keyword reveals that it is also related to “Billion”, “Bonus”, “Ken Lewis”, “Loss” and “No Salary”. This presentation gives the user an overview of the context before consuming the content. Additionally the related items on the record list are also underlined for the user to scan the descriptions before selecting it. As also depicted in FIG. 2, the mouse-over selection is not exclusive to the tag cloud, the mouse-over a record list item presents the underline highlight of its related keyword found in the tag cloud. In this example the keywords “Ken Lewis” and “Czar” are no longer underlined as they do not relate to the selected news article listed in the record list.

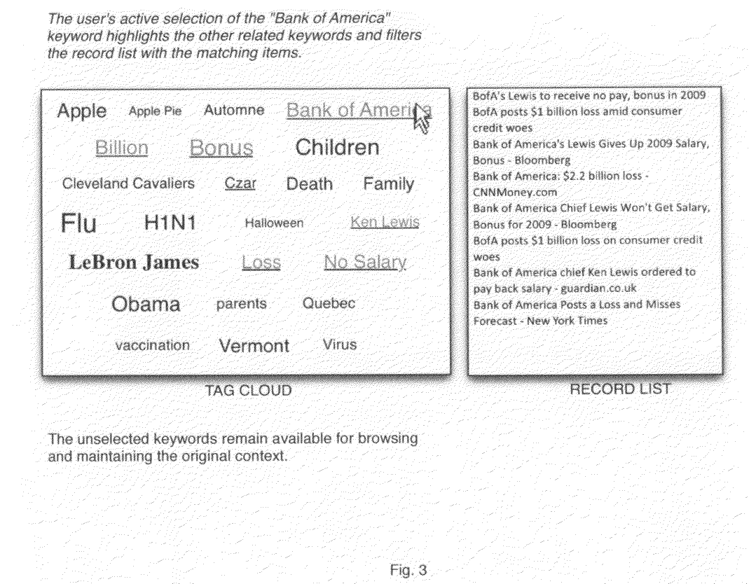

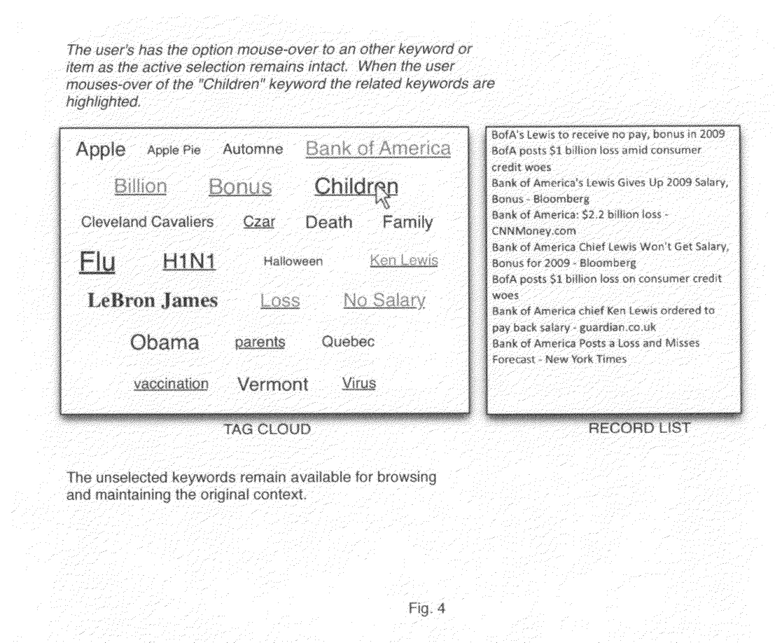

As depicted in FIG. 3., the user is now clicking on the “Bank of America” keyword and the related keyword in the tag cloud are now highlighted in green to be distinguished from subsequent mouse-over selections. The record list now only displays the records associated with the selection. The system also allows the user to choose more of the highlighted keywords to further refine the record list items. In this example, the system trims the items but not the tag cloud's keywords as they remain available for further mouse-over selection as shown in FIG. 4. Consequently, an active selection (mouse click) of a keyword that was excluded from the green highlighted selection would cause the highlight of its own related keywords and filtered items. This allows the user to jump from keyword cluster to keyword cluster within the same tag cloud without loosing the overall context.

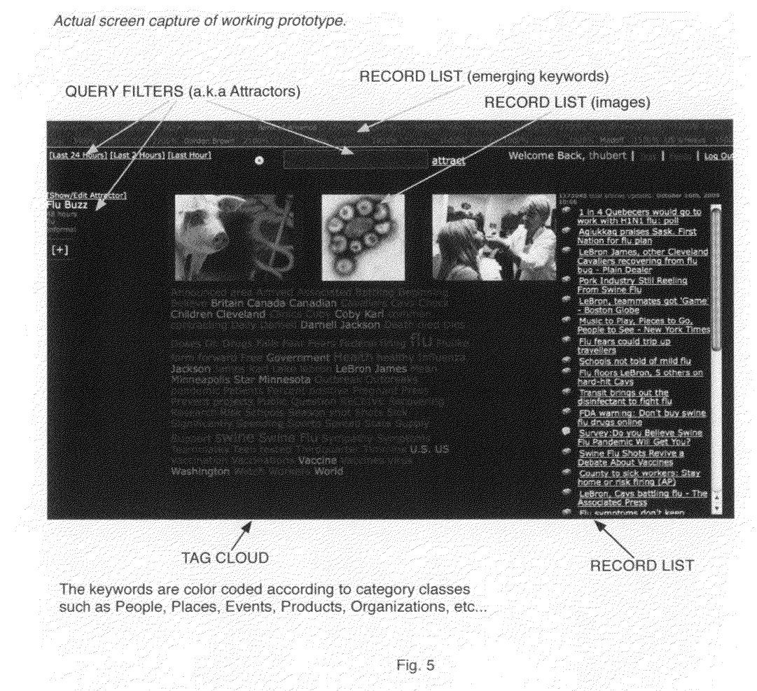

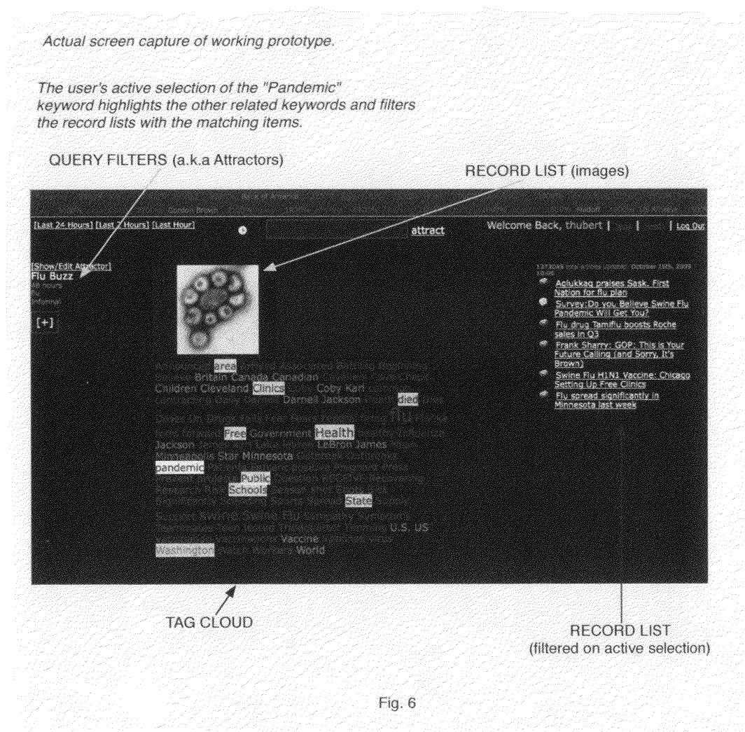

The invention is currently operational as depicted in the working prototype in FIGS. 5 & 6, the tag cloud is color enhanced to outline the different keyword classes. For example “red” is associated with events, and in this example the items are filtered with a 24 hours and “Flu” criteria found on Web news and blogger RSS sites. In this example the invention has populated the tag cloud and two record lists, one list with pictures and the second with articles; no selection other than the Flu and 24 hour query are in effect. The system has loaded the relationships awaiting selection to reveal them through highlights as depicted in FIG. 6. In FIG. 6. both record lists have been filtered while the tag cloud remains active for other selection. The FIGS. 5 & 6 also depicts richer a interface with filtering features that can be integrated to make full use of the present Invention.

In summary, in this method, a system or website presents the user with a tag cloud where the relationships have been established to allow the user to observe the correlated relationships and selected the keywords, tags and records in a method that explicitly shows their relationships. The methods also supports the ability for the filtered records and correlations to be refreshed by the user's interactions.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention.

1. A method comprising:
presenting to a user a tag cloud capable of highlighting correlations; wherein the tag cloud contains the relationships awaiting the user's passive (mouse-over) or active selection; selecting a keyword presents the user with correlated and highlighted keywords contained in the tag cloud.

2. The method in claim 1, further comprising highlighting related items displayed in the record list(s); and selecting a keyword filters the record list(s) to the specific items that are exclusive to the selection; and where subsequent keyword selections further refine the filtered record list items.

3. The method in claim 1, further comprising a passive user selection (mouse-over) of an item in a record list highlights its related keyword(s) displayed in the tag cloud.

4. The method in claim 1, a selection can occur from a pointing device capable of overing or selecting a keyword or item on a display device.

5. The method in claim 1, executed by a computer.

6. The method in claim 1, wherein the relationships are predefined.

7. The method in claim 1, wherein the tag clouds and record lists are from the same system.

8. A system that executes the method of claim 1.

9. A method comprising:
presenting to a user a tag cloud from a all-inclusive or filtered item selection; wherein the tag cloud comprises the correlated relationships between the records items and its keywords; and
presenting the user with highlighted keywords and record list items during the user's selection of the tag cloud keyword(s) or a record list item; and presenting the user a tag cloud that remains whole for further selection and browsing while maintaining its initial keyword presentation.
